(19) United States
(12) Patent Application Publication
(10) Pub. No.: US 2012/0011727 A1
(43) Pub. Date: Jan. 19, 2012

(54) Fork and Spoon Combination for Salad

(76) Inventor: Heng-Te Yang, Tainan City (TW)

(21) Appl. No.: 12/837,580

(22) Filed: Jul. 16, 2010

(51) Int. Cl. A47J 43/28

(52) U.S. Cl. 30/150

(57) ABSTRACT

A fork and spoon combination for salad includes a fork (21) and a spoon (22) detachably and pivotally connected with the fork. The fork has a first magnet (211) and a pivot slot (212). The spoon has a second magnet (201) magnetically attracted by the first magnet of the fork and a pivot shaft (202) pivotally mounted in the pivot slot of the fork. Thus, when the spoon is detached from the fork, the spoon and the fork are used individually to stir and blend the salad, and when the spoon is pivotally connected with the fork, the fork and spoon combination can function as a clip to pick and take the salad so that the fork and spoon combination can be used to stir and blend the salad and can also function as a clip to pick and take the salad.

### BACKGROUND OF THE INVENTION

1. Field of the Invention

The present invention relates to a kitchen utensil and, more particularly, to a fork and spoon combination for salad.

2. Description of the Related Art

A conventional salad tool in accordance with the prior art shown in FIG. 9 comprises two spoons 1 that are used to stir and blend salad 12 in a salad dish 10. Thus, when the salad is formed, the two spoons 1 can abut each other to pick and take the salad 12 in the salad dish 10. However, the user's two hands have to hold the two spoons 1 so that the user cannot hold the salad dish 10 to pick and take the salad 12 in the salad dish 10, thereby greatly causing inconvenience to the user when picking and taking the salad 12.

### BRIEF SUMMARY OF THE INVENTION

In accordance with the present invention, there is provided a fork and spoon combination, comprising a fork and a spoon detachably and pivotally connected with the fork.

The fork has an inner face provided with a first magnet and a pivot slot. The spoon has an inner face provided with a second magnet aligning with and magnetically attracted by the first magnet of the fork and a pivot shaft pivotally mounted in the pivot slot of the fork.

Preferably, the pivot slot of the fork has a substantially semi-circular shape, and the pivot shaft of the spoon has a substantially semi-circular shape matching that of the pivot slot of the fork.

Alternatively, the pivot slot of the fork has a substantially triangular shape, and the pivot shaft of the spoon has a substantially triangular shape matching that of the pivot slot of the fork.

The pivot slot of the fork extends in a transverse direction of the fork. The pivot shaft of the spoon extends in a transverse direction of the spoon. The pivot shaft of the spoon is detachably mounted in the pivot slot of the fork.

The fork has a first end provided with the first magnet and a second end provided with a first holding portion. The pivot slot of the fork is located between the first magnet and the first holding portion, and a distance between the first magnet and the pivot slot is smaller than that between the pivot slot and the first holding portion. The spoon has a first end provided with the second magnet and a second end provided with a second holding portion facing the first holding portion of the fork. The pivot shaft of the spoon is located between the second magnet and the second holding portion, and a distance between the second magnet and the pivot shaft is smaller than that between the pivot shaft and the second holding portion.

The spoon is detachable from the fork so that the spoon and the fork of the fork and spoon combination are operable individually. The pivot shaft of the spoon is pivotable in the pivot slot of the fork so that the spoon and the fork are pivotable relative to each other, and the fork and spoon combination is operable as a clip.

The primary objective of the present invention is to provide a fork and spoon combination that can function as a salad stirring tool to stir and blend the salad and can also function as a clip to pick and take the salad.

According to the primary advantage of the present invention, when the spoon is detached from the fork, the spoon and the fork of the fork and spoon combination are used individually to stir and blend the salad, and when the spoon is pivotally connected with the fork, the fork and spoon combination can function as a clip to pick and take the salad so that the fork and spoon combination can be used to stir and blend the salad and can also function as a clip to pick and take the salad, thereby enhancing the versatility of the fork and spoon combination.

According to another advantage of the present invention, a user can hold the salad disk by his one hand and hold the fork and spoon combination by his other hand so that the user can hold the salad disk and operate the fork and spoon combination to pick and take the salad on the salad disk simultaneously, thereby facilitating the user operating the fork and spoon combination and picking the salad.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a fork and spoon combination in accordance with the preferred embodiment of the present invention.

FIG. 2 is an exploded perspective view of the fork and spoon combination as shown in FIG. 1.

FIG. 3 is another exploded perspective view of the fork and spoon combination as shown in FIG. 1.

FIG. 4 is a locally enlarged view of a spoon of the fork and spoon combination as shown in FIG. 3.

FIG. 5 is a locally enlarged view of a fork of the fork and spoon combination as shown in FIG. 3.

FIG. 6 is a front cross-sectional view of the fork and spoon combination as shown in FIG. 1.

FIG. 7 is a schematic operational view of the fork and spoon combination as shown in FIG. 1 in use.

FIG. 8 is a front cross-sectional view of a fork and spoon combination in accordance with another preferred embodiment of the present invention.

FIG. 9 is a perspective view of a conventional salad tool in accordance with the prior art.

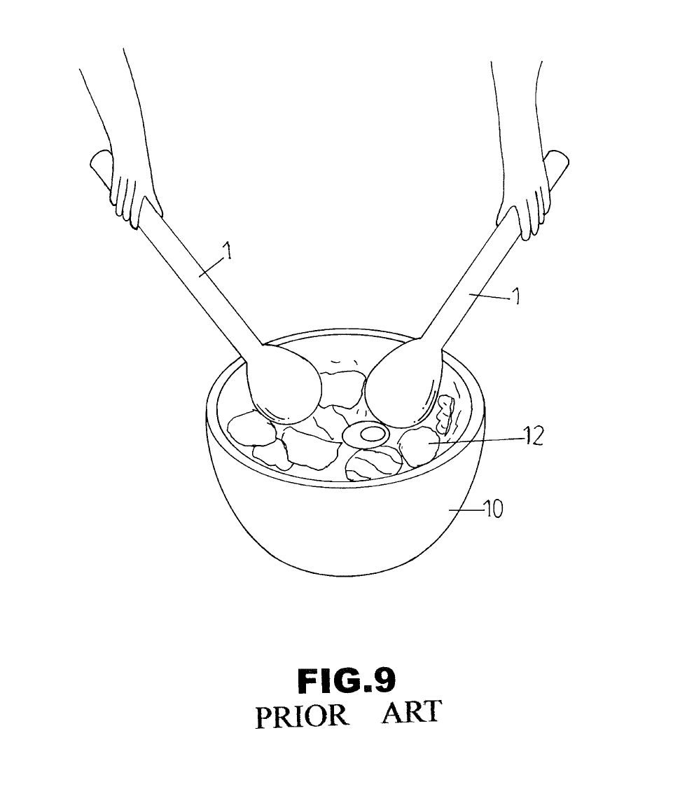

### DETAILED DESCRIPTION OF THE INVENTION

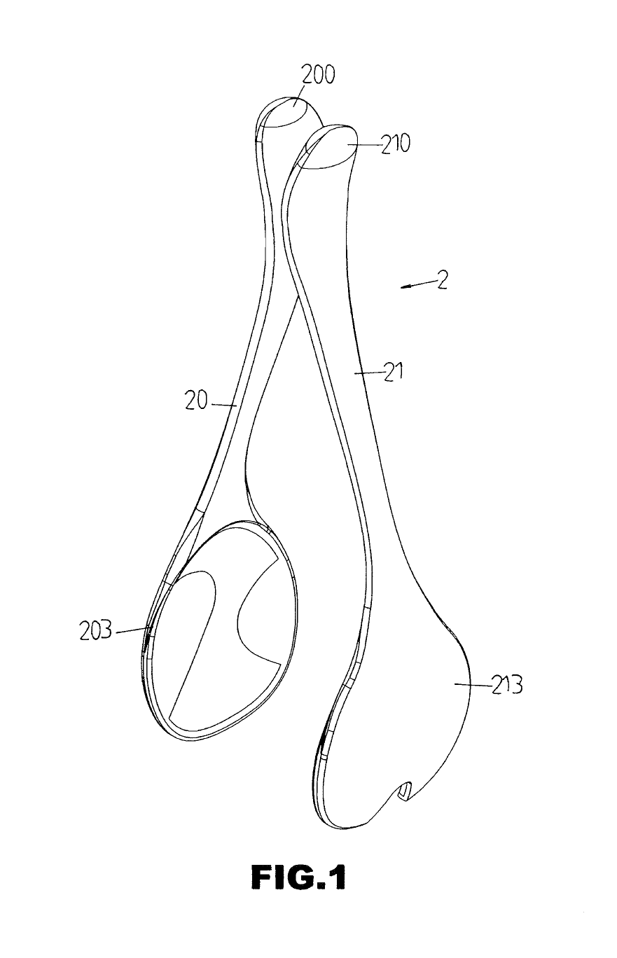

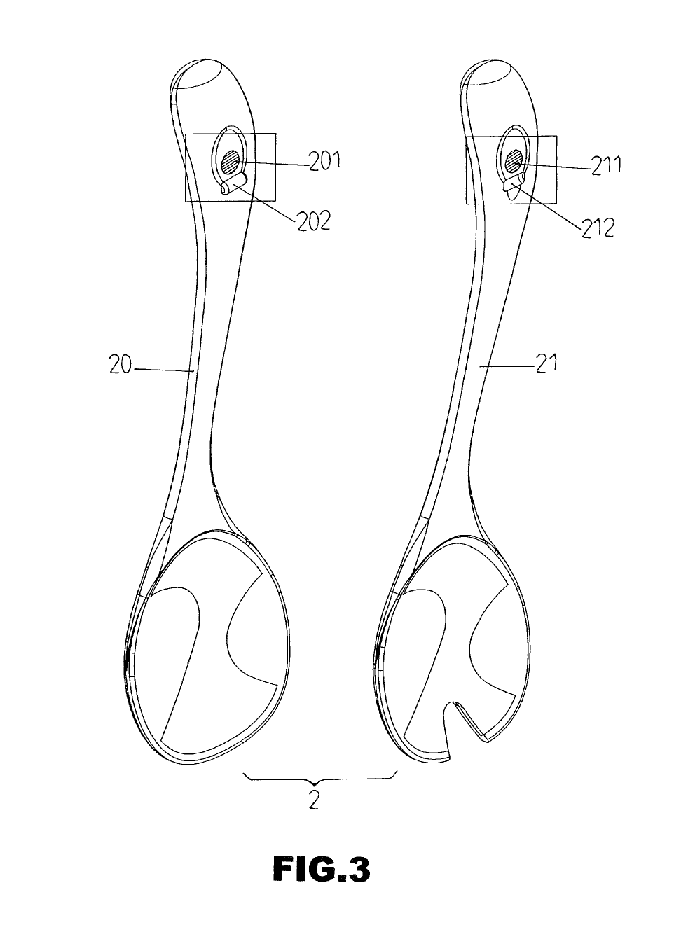

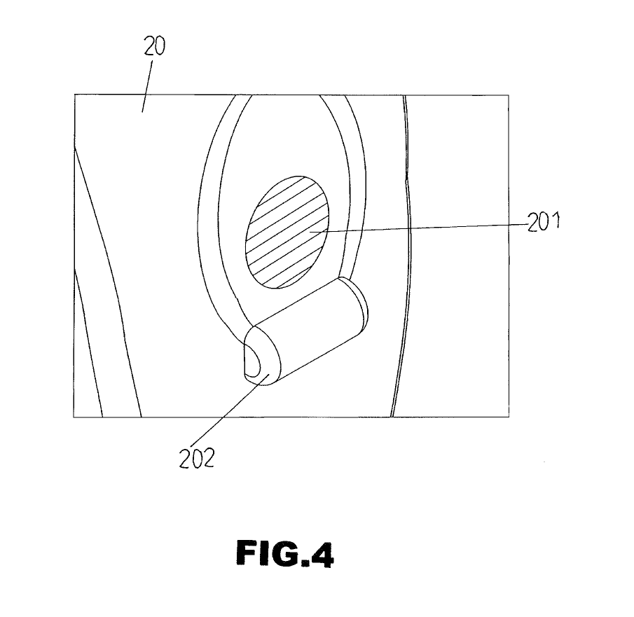

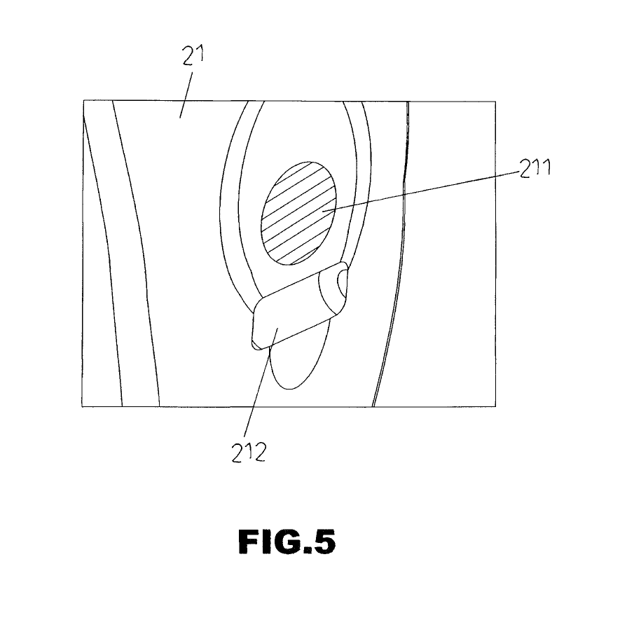

Referring to the drawings and initially to FIGS. 1-6, a fork and spoon combination 2 for salad in accordance with the preferred embodiment of the present invention comprises a fork 21 and a spoon 20 detachably and pivotally connected with the fork 21.

The fork 21 has an inner face provided with a first magnet 211 and a pivot slot 212. The pivot slot 212 of the fork 21 has a substantially semi-circular shape and extends in a transverse direction of the fork 21. The fork 21 has a first end provided with the first magnet 211 and a second end provided with a first holding portion 213. The pivot slot 212 of the fork 21 is located between the first magnet 211 and the first holding portion 213, and a distance between the first magnet 211 and the pivot slot 212 is smaller than that between the pivot slot 212 and the first holding portion 213.

The spoon 20 has an inner face provided with a second magnet 201 aligning with and magnetically attracted by the first magnet 211 of the fork 21 and a pivot shaft 202 pivotally mounted in the pivot slot 212 of the fork 21. The second magnet 201 of the spoon 20 has a pole opposite to that of the first magnet 211 of the fork 21. The pivot shaft 202 of the spoon 20 has a substantially semi-circular shape matching that of the pivot slot 212 of the fork 21 and extends in a transverse direction of the spoon 20. The pivot shaft 202 of the spoon 20 is detachably mounted in the pivot slot 212 of the fork 21. The spoon 20 has a first end provided with the second magnet 201 and a second end provided with a second holding portion 203 facing the first holding portion 213 of the fork 21. The pivot shaft 202 of the spoon 20 is located between the second magnet 201 and the second holding portion 203, and a distance between the second magnet 201 and the pivot shaft 202 is smaller than that between the pivot shaft 202 and the second holding portion 203.

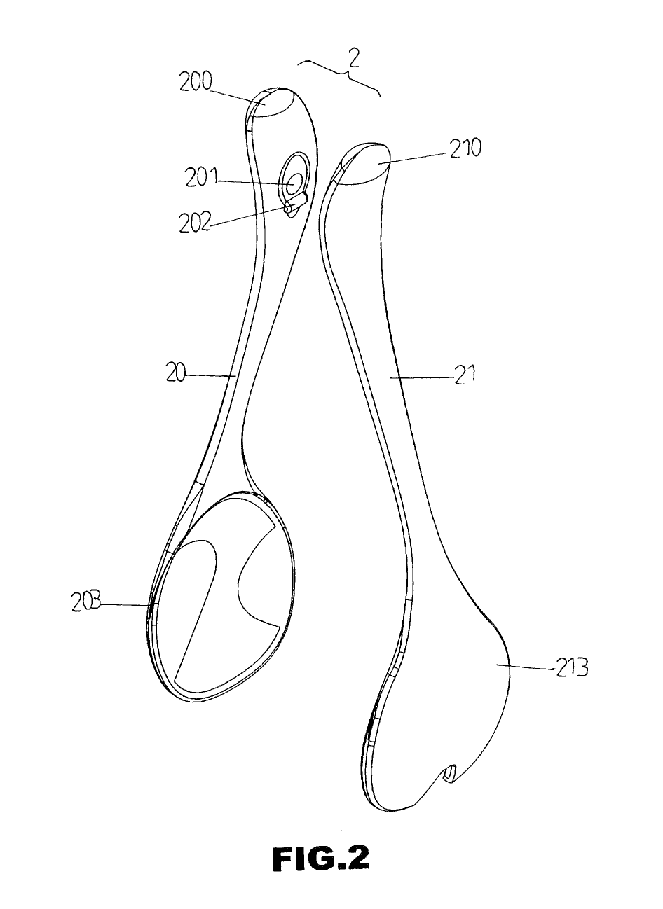

As shown in FIG. 2, the spoon 20 is detached from the fork 21 so that the spoon 20 and the fork 21 of the fork and spoon combination 2 are used individually to stir and blend the salad.

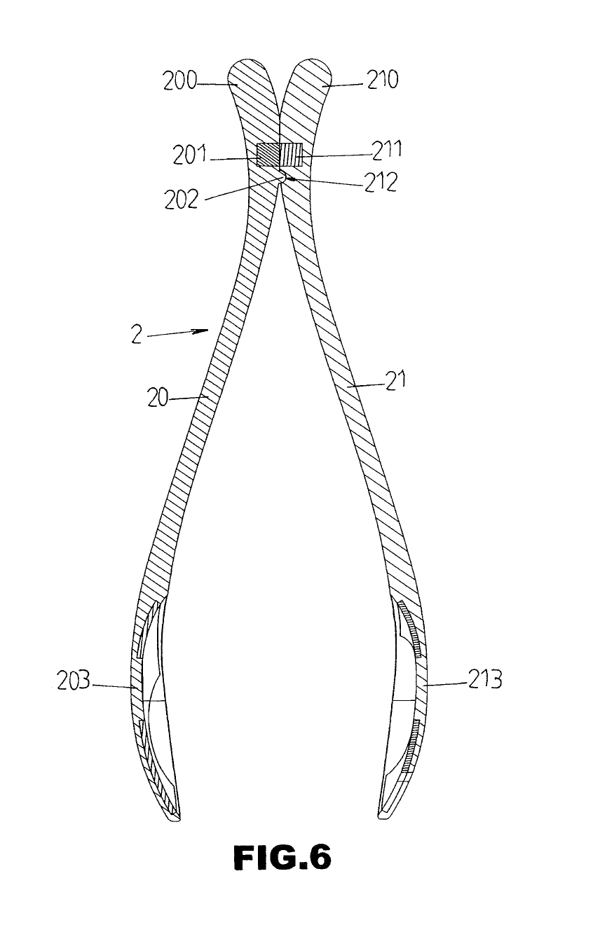

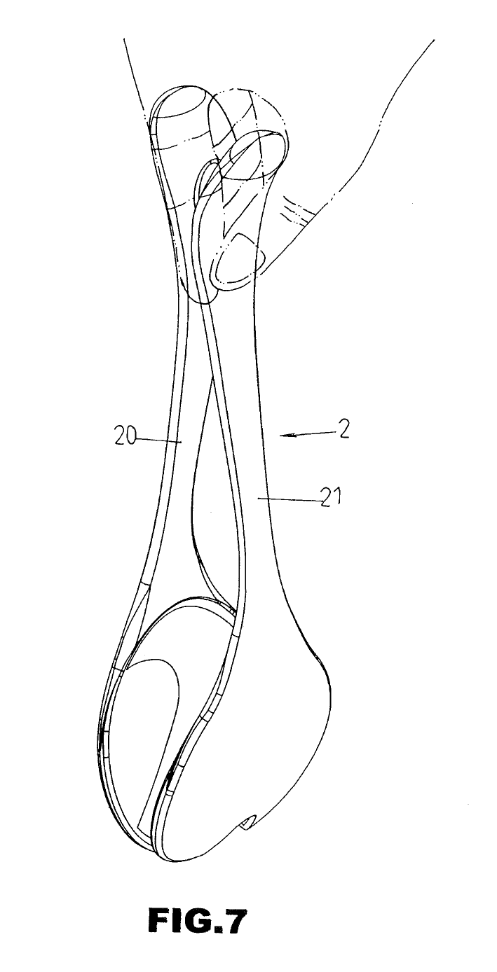

As shown in FIGS. 6 and 7, the spoon 20 is connected with the fork 21, and the pivot shaft 202 of the spoon 20 is pivoted in the pivot slot 212 of the fork 21 so that the spoon 20 and the fork 21 are pivoted relative to each other, and the fork and spoon combination 2 can function as a clip to pick and take the salad by the first holding portion 213 of the fork 21 and the second holding portion 203 of the spoon 20.

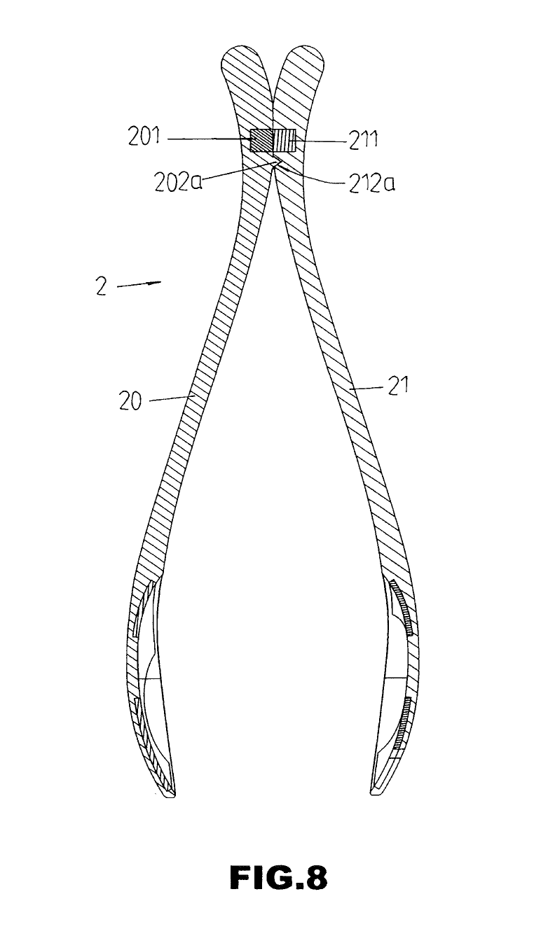

Referring to FIG. 8, the pivot slot 212a of the fork 21 has a substantially triangular shape, and the pivot shaft 202 of the spoon 20 has a substantially triangular shape matching that of the pivot slot 212a of the fork 21.

Accordingly, when the spoon 20 is detached from the fork 21, the spoon 20 and the fork 21 of the fork and spoon combination 2 are used individually to stir and blend the salad, and when the spoon 20 is pivotally connected with the fork 21, the fork and spoon combination 2 can function as a clip to pick and take the salad so that the fork and spoon combination 2 can be used to stir and blend the salad and can also function as a clip to pick and take the salad, thereby enhancing the versatility of the fork and spoon combination 2. In addition, a user can hold the salad disk by his one hand and hold the fork and spoon combination 2 by his other hand so that the user can hold the salad disk and operate the fork and spoon combination 2 to pick and take the salad on the salad disk simultaneously, thereby facilitating the user operating the fork and spoon combination 2 and picking the salad.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A fork and spoon combination, comprising:
a fork; and
a spoon detachably and pivotally connected with the fork.

2. The fork and spoon combination of claim 1, wherein
the fork has an inner face provided with a first magnet and a pivot slot;
the spoon has an inner face provided with a second magnet aligning with and magnetically attracted by the first magnet of the fork and a pivot shaft pivotally mounted in the pivot slot of the fork.

3. The fork and spoon combination of claim 2, wherein
the pivot slot of the fork has a substantially semi-circular shape;
the pivot shaft of the spoon has a substantially semi-circular shape matching that of the pivot slot of the fork.

4. The fork and spoon combination of claim 2, wherein the second magnet of the spoon has a pole opposite to that of the first magnet of the fork.

5. The fork and spoon combination of claim 2, wherein
the pivot slot of the fork has a substantially triangular shape; and
the pivot shaft of the spoon has a substantially triangular shape matching that of the pivot slot of the fork.

6. The fork and spoon combination of claim 2, wherein
the pivot slot of the fork extends in a transverse direction of the fork;
the pivot shaft of the spoon extends in a transverse direction of the spoon.

7. The fork and spoon combination of claim 2, wherein the pivot shaft of the spoon is detachably mounted in the pivot slot of the fork.

8. The fork and spoon combination of claim 2, wherein
the fork has a first end provided with the first magnet and a second end provided with a first holding portion;
the pivot slot of the fork is located between the first magnet and the first holding portion;
a distance between the first magnet and the pivot slot is smaller than that between the pivot slot and the first holding portion;
the spoon has a first end provided with the second magnet and a second end provided with a second holding portion facing the first holding portion of the fork;
the pivot shaft of the spoon is located between the second magnet and the second holding portion;
a distance between the second magnet and the pivot shaft is smaller than that between the pivot shaft and the second holding portion.

9. The fork and spoon combination of claim 2, wherein the spoon is detachable from the fork so that the spoon and the fork of the fork and spoon combination are operable individually.

10. The fork and spoon combination of claim 1, wherein
the pivot shaft of the spoon is pivotable in the pivot slot of the fork;
the spoon and the fork are pivotable relative to each other; and
the fork and spoon combination is operable as a clip.
